(19) United States
(12) Patent Application Publication
(10) Pub. No.: US 2003/0135720 A1
(43) Pub. Date: Jul. 17, 2003

(54) Method and system using hardware assistance for instruction tracing with secondary set of interruption resources

(75) Inventors: Jimmie Earl DeWitt JR., Georgetown, TX (US); Riaz Y. Hussain, Austin, TX (US); Frank Eliot Levine, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 10/045,537

(22) Filed: Jan. 14, 2002

(51) Int. Cl. G06F 9/00

(52) U.S. Cl. 712/228; 712/244; 712/227

(57) ABSTRACT

A method, system, apparatus, and computer program product is presented for processing instructions. A processor is able to receive multiple types of interruptions while executing instructions. The types of interruptions can include aborts, faults, interrupts, and traps. The processor has a plurality of interruption resources, such as interruption control registers, in which a type of interruption can be associated with a specific interruption resource. In response to receiving an interruption, the processor saves processor state information into an interruption resource based on the type of the received interruption, after which the processor invokes an interruption handler to process the received interruption. The processor is able to save a first processor state to a first interruption resource while saving a second processor state to a second interruption resource, thereby allowing the processor to save processor state information on single-step and taken branch interruptions so that other interruptions can be traced.

### BACKGROUND OF THE INVENTION

1. Field of the Invention

The present invention relates generally to an improved data processing system and, in particular, to a method and system for instruction processing within a processor in a data processing system.

2. Description of Related Art

In analyzing the performance of a data processing system and/or the applications executing within the data processing system, it is helpful to understand the execution flows and the use of system resources. Performance tools are used to monitor and examine a data processing system to determine resource consumption as various software applications are executing within the data processing system. For example, a performance tool may identify the most frequently executed modules and instructions in a data processing system, or it may identify those modules which allocate the largest amount of memory or perform the most I/O requests. Hardware performance tools may be built into the system or added at a later point in time. Software performance tools also are useful in data processing systems, such as personal computer systems, which typically do not contain many, if any, built-in hardware performance tools.

One known software performance tool is a trace tool. A trace tool may use more than one technique to provide trace information that indicates execution flows for an executing program. For example, a trace tool may log every entry into, and every exit from, a module, subroutine, method, function, or system component. Alternately, a trace tool may log the amounts of memory allocated for each memory allocation request and the identity of the requesting thread. Typically, a time-stamped record is produced for each such event. Corresponding pairs of records similar to entry-exit records also are used to trace execution of arbitrary code segments, starting and completing I/O or data transmission, and for many other events of interest.

In order to improve software performance, it is often necessary to determine where time is being spent by the processor in executing code, such efforts being commonly known in the computer processing arts as locating “hot spots.” Within these hot spots, there may be lines of code that are frequently executed. When there is a point in the code where one of two or more branches may be taken, it is useful to know which branch is the mainline path, or the branch most frequently taken, and which branch or branches are the exception branches. Grouping the instructions in the mainline branches of the module closely together also increases the likelihood of cache hits because the mainline code is the code that will most likely be loaded into the instruction cache.

Ideally, one would like to isolate such hot spots at the instruction level and/or source line level in order to focus attention on areas which might benefit most from improvements to the code. For example, isolating such hot spots to the instruction level permits a compiler developer to find significant areas of suboptimal code generation. Another potential use of instruction level detail is to provide guidance to CPU developers in order to find characteristic instruction sequences that should be optimized on a given type of processor.

Another analytical methodology is instruction tracing by which an attempt is made to log every executed instruction. Instruction tracing is an important analytical tool for discovering the lowest level of behavior of a portion of software.

However, implementing an instruction tracing methodology is a difficult task to perform reliably because the tracing program itself causes some interrupts to occur. If the tracing program is monitoring interrupts and generating trace output records for those interrupts, then the tracing program may log interrupts that it has caused through its own operations. In that case, it would be more difficult for a system analyst to interpret the trace output during a post-processing phase because the information for the interrupts caused by the tracing program must first be recognized and then must be filtered or ignored when recognized.

More specifically, instruction tracing may cause interrupts while trying to record trace information because the act of accessing an instruction may cause interrupts, thereby causing unwanted effects at the time of the interrupt and generating unwanted trace output information. A prior art instruction tracing technique records information about the next instruction that is about to be executed. In order to merely log the instruction before it is executed, several interrupts can be generated with older processor architectures, such as the X86 family, while simply trying to access the instruction before it is executed. For example, an instruction cache miss may be generated because the instruction has not yet been fetched into the instruction cache, and if the instruction straddles a cache line boundary, another instruction cache miss would be generated. Similarly, there could be one or two data cache misses for the instruction's operands, each of which could also trigger a page fault.

Another problem is that processors have limited resources for supporting interrupt handling, and the actions of a tracing program consume the interrupt resources that are needed by the application program that is being analyzed. For example, a tracing program logs information by gaining execution control through the use of various types of interrupts and/or traps, such as a single-step trap or a taken-branch trap. While the tracing program is performing its tracing operations, other interrupts may occur concurrently. However, if the tracing program has other interrupts disabled while it is performing its operations, the trace output may not have a valid snapshot of the events associated with the execution of the application program.

Therefore, it would be advantageous to have hardware structures within the processor that assist the tracing operations of a tracing program in order to provide a more complete snapshot of the system that is being analyzed.

### SUMMARY OF THE INVENTION

A method, system, apparatus, and computer program product is presented for processing instructions. A processor is able to receive multiple types of interruptions while executing instructions. The types of interruptions can include aborts, faults, interrupts, and traps. The processor has a plurality of interruption resources, such as interruption control registers, in which a type of interruption can be associated with a specific interruption resource. In response to receiving an interruption, the processor saves processor state information into an interruption resource based on the type of the received interruption, after which the processor invokes an interruption handler to process the received interruption. The processor is able to save a first processor state to a first interruption resource while saving a second processor state to a second interruption resource, thereby allowing the processor to save processor state information on single-step and taken branch interruptions so that other interruptions can be traced.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical data processing system in which the present invention may be implemented;

FIG. 1B depicts typical structures in a processor and a memory subsystem in which the present invention may be implemented;

FIG. 1C depicts data structures within a processor that are used during a typical response to an interrupt;

FIG. 1D depicts typical software components within a computer system illustrating a logical relationship between the components as functional layers of software;

FIG. 1E depicts a typical relationship between software components in a data processing system that is being analyzed in some manner by a trace facility;

FIG. 1F depicts typical phases that may be used to characterize the operation of a tracing facility;

FIG. 2A depicts a processor with two sets of interrupt resources into which a processor's current state may be saved in accordance with the present invention; and

FIG. 2B depicts a process in which two sets of interruption resources are available for processing a trap concurrently with an interrupt in accordance with the present invention.

### DETAILED DESCRIPTION OF THE INVENTION

The present invention is directed to hardware structures within a processor that assist tracing operations. As background, a typical organization of hardware and software components within a data processing system is described prior to describing the present invention in more detail.

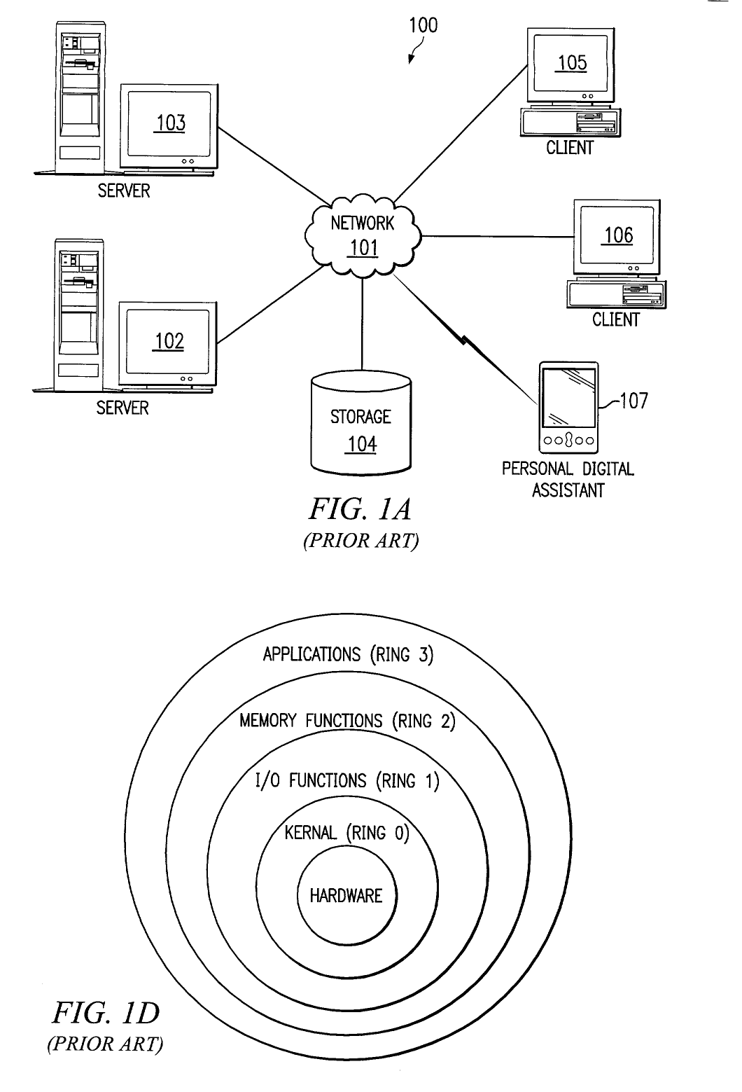

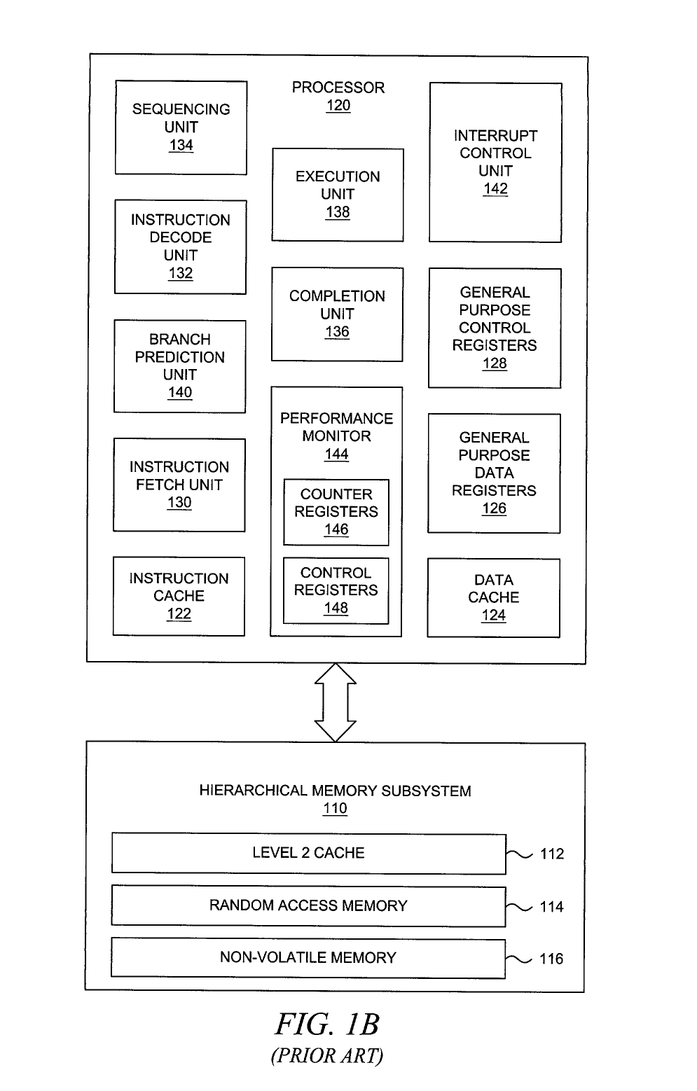

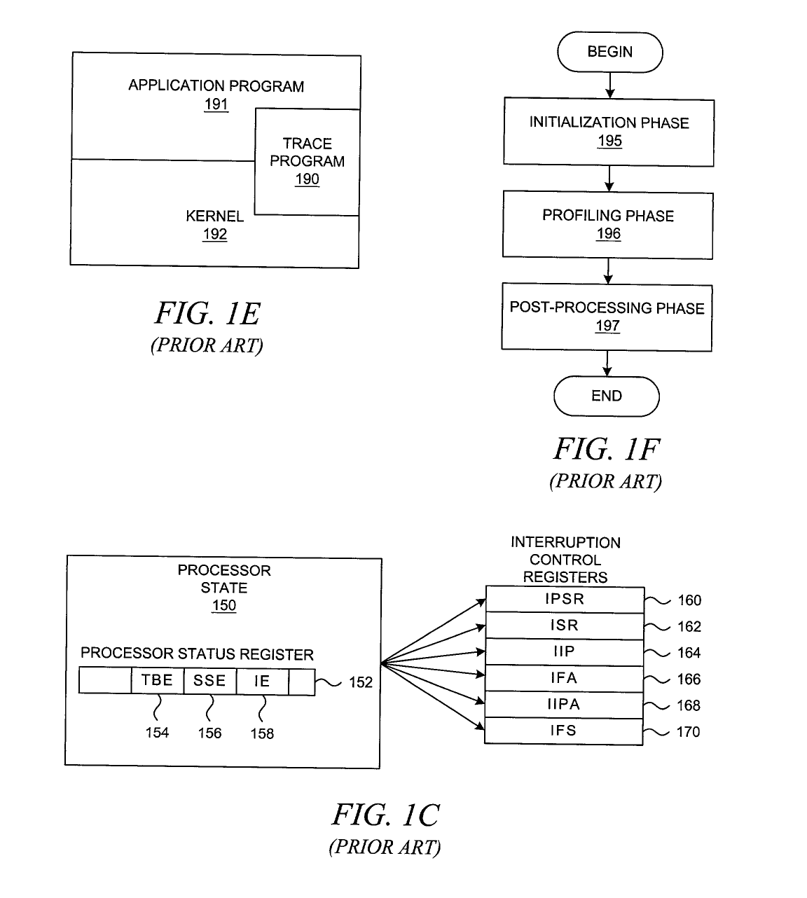

With reference now to the figures, FIG. 1A depicts a typical data processing system in which the present invention may be implemented. Data processing system 100 contains network 101, which is the medium used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 may be a variety of computing devices, such as personal computers, personal digital assistants (PDAs), etc. Distributed data processing system 100 may include additional servers, clients, and other devices not shown. In the depicted example, distributed data processing system 100 may include the Internet with network 101 representing a worldwide collection of networks and gateways that use the TCP/IP suite of protocols to communicate with one another. Of course, distributed data processing system 100 may also be configured to include a number of different types of networks, such as, for example, an intranet, a local area network (LAN), or a wide area network (WAN).

FIG. 1A is intended as an example of a heterogeneous computing environment and not as an architectural limitation for the present invention. The present invention could be implemented on a variety of hardware platforms, such as server 102 or client 107 shown in FIG. 1A. Requests for the collection of performance information may be initiated on a first device within the network, while a second device within the network receives the request, collects the performance information for applications executing on the second device, and returns the collected data to the first device.

With reference now to FIG. 1B, a block diagram depicts typical structures in a processor and a memory subsystem that may be used within a client or server, such as those shown in FIG. 1A, in which the present invention may be implemented. Hierarchical memory 110 comprises Level 2 cache 112, random access memory (RAM) 114, and non-volatile memory 116. Level 2 cache 112 provides a fast access cache to data and instructions that may be stored in RAM 114 in a manner which is well-known in the art. RAM 114 provides main memory storage for data and instructions that may also provide a cache for data and instructions stored in nonvolatile memory 116, such as a flash memory or a disk drive.

Processor 120 comprises a pipelined processor capable of executing multiple instructions in a single cycle. During operation of the data processing system, instructions and data are stored in hierarchical memory 110. Data and instructions may be transferred to processor 120 from hierarchical memory 110 on a common data path/bus or on independent data paths/buses. In either case, processor 120 may provide separate instruction and data transfer paths within processor 120 in conjunction with instruction cache 122 and data cache 124. Instruction cache 122 contains instructions that have been cached for execution within the processor. Some instructions may transfer data to or from hierarchical memory 110 via data cache 124. Other instructions may operate on data that has already been loaded into general purpose data registers 126, while other instructions may perform a control operation with respect to general purpose control registers 128.

Fetch unit 130 retrieves instructions from instruction cache 122 as necessary, which in turn retrieves instructions from memory 110 as necessary. Decode unit 132 decodes instructions to determine basic information about the instruction, such as instruction type, source registers, and destination registers.

In this example, processor 120 is depicted as an out-of-order execution processor. Sequencing unit 134 uses the decoded information to schedule instructions for execution. In order to track instructions, completion unit 136 may have data and control structures for storing and retrieving information about scheduled instructions. As the instructions are executed by execution unit 138, information concerning the executing and executed instructions is collected by completion unit 136. Execution unit 138 may use multiple execution subunits. As instructions complete, completion unit 136 commits the results of the execution of the instructions; the destination registers of the instructions are made available for use by subsequent instructions, or the values in the destination registers are indicated as valid through the use of various control flags. Subsequent instructions may be issued to the appropriate execution subunit as soon as its source data is available.

In this example, processor 120 is also depicted as a speculative execution processor. Generally, instructions are fetched and completed sequentially until a branch-type instruction alters the instruction flow, either conditionally or unconditionally. After decode unit 132 recognizes a conditional branch operation, sequencing unit 134 may recognize that the data upon which the condition is based is not yet available; e.g., the instruction that will produce the necessary data has not been executed. In this case, fetch unit 130 may use one or more branch prediction mechanisms in branch prediction unit 140 to predict the outcome of the condition. Control is then speculatively altered until the results of the condition can be determined. Depending on the capabilities of the processor, multiple prediction paths may be followed, and unnecessary branches are flushed from the execution pipeline.

Since speculative instructions can not complete until the branch condition is resolved, many high performance out-of-order processors provide a mechanism to map physical registers to virtual registers. The result of execution is written to the virtual register when the instruction has finished executing. Physical registers are not updated until an instruction actually completes. Any instructions dependent upon the results of a previous instruction may begin execution as soon as the virtual register is written. In this way, a long stream of speculative instructions can be executed before determining the outcome of a conditional branch.

Interrupt control unit 142 controls events that occur during instruction processing that cause execution flow control to be passed to an interrupt handling routine. A certain amount of the processor's state at the time of the interrupt is saved automatically by the processor. After completion of interruption processing, a return-from-interrupt (so-called “RFI” in the Intel® IA-64 architecture) can be executed to restore the saved processor state, at which time the processor can proceed with the execution of the interrupted instruction. Interrupt control unit 142 may comprise various data registers and control registers that assist the processing of an interrupt.

Certain events occur within the processor as instructions are executed, such as cache accesses or Translation Lookaside Buffer (TLB) misses. Performance monitor 144 monitors those events and accumulates counts of events that occur as the result of processing instructions. Performance monitor 144 is a software-accessible mechanism intended to provide information concerning instruction execution and data storage; its counter registers and control registers can be read or written under software control via special instructions for that purpose. Performance monitor 144 contains a plurality of performance monitor counters (PMCs) or counter registers 146 that count events under the control of one or more control registers 148. The control registers are typically partitioned into bit fields that allow for event/signal selection and accumulation. Selection of an allowable combination of events causes the counters to operate concurrently; the performance monitor may be used as a mechanism to monitor the performance of the stages of the instruction pipeline.

With reference now to FIG. 1C, a block diagram depicts data structures within a processor that are used during a typical response to an interrupt. At any given point in time, the processor can be described by its processor state 150, which is the value of the processor's registers, caches, and other data structures and signals. In some processors, registers are categorized as application-level registers and system-level registers. Processor status register (PSR) 152 is a system-level register that contains many of the important values for describing the processor state; only a few flags within PSR 152 are shown in the example. PSR 152 may be considered to be similar to one of the general purpose control registers that are shown in FIG. 1B.

PSR 152 contains taken-branch-enable (TBE) flag 154 that causes a taken-branch trap to occur when a branch-type instruction is successfully completed. PSR 152 also contains single-step-enable (SSE) flag 156 that causes a single-step trap to occur following a successful execution of an instruction. Interrupt-enable (IE) flag 158 indicates whether interrupts will be fielded, i.e., whether external interrupts will cause the processor to transfer control to an external interrupt handler.

When an interrupt or trap occurs, such as a taken-branch trap or a single-step trap, a portion of the current state of the processor is saved. After interruption processing, the saved processor state can be restored so that the interrupted execution flow may resume. In this example, values are saved and/or generated and stored into a set of interruption control registers, which may be considered to be similar to a subset of the general purpose control registers that are shown in FIG. 1B or which may be special registers within interrupt control unit 142. Interruption processor status register (IPSR) 160 receives the value of PSR 152. Interruption status register (ISR) 162 receives information related to the nature of the interruption; multiple interrupts, including nested interrupts, may occur concurrently, and these may be reflected in the status bits within ISR 162. Interruption instruction pointer (IIP) register 164 receives the value of the instruction pointer; for traps and interrupts, IIP 164 may point to the next instruction, whereas IIP 164 may point to the faulting instruction for various types of fault conditions. Interruption faulting address (IFA) register 166 receives the address that raised the fault condition. Interruption instruction previous address (IIPA) register 168 records the address of the most recently executed instruction, i.e., the last successfully executed instruction. Interruption fault state (IFS) register 170 is used to reload the current register stack frame on a return-from-interruption. Other registers may be saved and/or loaded with values as required by a particular processor's architecture.

Those of ordinary skill in the art will appreciate that the hardware shown in FIG. 1B and FIG. 1C may vary depending on the system implementation. The depicted example is not meant to imply architectural limitations with respect to the present invention.

With reference now to FIG. 1D, a prior art diagram shows software components within a computer system illustrating a logical relationship between the components as functional layers of software. The kernel (Ring 0) of the operating system provides a core set of functions that acts as an interface to the hardware. I/O functions and drivers can be viewed as resident in Ring 1, while memory management and memory-related functions are resident in Ring 2. User applications and other programs (Ring 3) access the functions in the other layers to perform general data processing. Rings 0-2, as a whole, may be viewed as the operating system of a particular device. Assuming that the operating system is extensible, software drivers may be added to the operating system to support various additional functions required by user applications, such as device drivers for support of new devices added to the system.

In addition to being able to be implemented on a variety of hardware platforms, the present invention may be implemented in a variety of software environments. A typical operating system may be used to control program execution within each data processing system. For example, one device may run a Linux® operating system, while another device may run an AIX® operating system.

With reference now to FIG. 1E, a simple block diagram depicts a typical relationship between software components in a data processing system that is being analyzed in some manner by a trace facility. Trace program 190 is used to analyze application program 191 Trace program 190 may be configured to handle a subset of interrupts on the data processing system that is being analyzed. When an interrupt or trap occurs, e.g., a single-step trap or a taken-branch trap, functionality within trace program 190 can perform various tracing functions, profiling functions, or debugging functions; hereinafter, the terms tracing, profiling, and debugging are used interchangeably. In addition, trace program 190 may be used to record data upon the execution of a hook, which is a specialized piece of code at a specific location in an application process. Trace hooks are typically inserted for the purpose of debugging, performance analysis, or enhancing functionality. Typically, trace program 190 generates trace data of various types of information, which is stored in a trace data buffer and subsequently written to a data file for post-processing.

Both trace program 190 and application program 191 use kernel 192, which comprises and/or supports system-level calls, utilities, and device drivers. Depending on the implementation, trace program 190 may have some modules that run at an application-level priority and other modules that run at a trusted, system-level priority with various system-level privileges.

It should be noted that the instruction tracing functionality of the present invention may be placed in a variety of contexts, including a kernel, a kernel driver, an operating system module, or a tracing process or program. Hereinafter, the term “tracing program” or “tracing software” is used to simplify the distinction versus typical kernel functionality and the processes generated by an application program. In other words, the executable code of the tracing program may be placed into various types of processes, including interrupt handlers.

In addition, it should be noted that hereinafter the term “current instruction address” or “next instruction” refers to an instruction within an application that is being profiled/traced and does not refer to the next instruction within the profiling/tracing program. It is assumed that the processor and/or operating system has saved the instruction pointer that was being used during the execution of the application program in order to initiate an interrupt handler; the instruction pointer would be saved into a special register or stack frame, and this saved value is retrievable by the tracing program. Hence, unless specifically stated otherwise, when the value of the instruction pointer is discussed, one refers to the value of the instruction pointer for the application program at the point in time at which the application program was interrupted.

With reference now to FIG. 1F, a diagram depicts typical phases that may be used to characterize the operation of a tracing facility. An initialization phase 195 is used to capture the state of the client machine at the time tracing is initiated. This trace initialization data may include trace records that identify all existing threads, all loaded classes, and all methods for the loaded classes; subsequently generated trace data may indicate thread switches, interrupts, and loading and unloading of classes and jitted methods. A special record may be written to indicate within the trace output when all of the startup information has been written.

Next, during the profiling phase 196, trace records are written to a trace buffer or file. Subject to memory constraints, the generated trace output may be as long and as detailed as an analyst requires for the purpose of profiling or debugging a particular program.

In the post-processing phase 197, the data collected in the buffer is sent to a file for post-processing. During post-processing phase 197, each trace record is processed in accordance with the type of information within the trace record. After all of the trace records are processed, the information is typically formatted for output in the form of a report. The trace output may be sent to a server, which analyzes the trace output from processes on a client. Of course, depending on available resources or other considerations, the post-processing also may be performed on the client. Alternatively, trace information may be processed on-the-fly so that trace data structures are maintained during the profiling phase.

As mentioned previously, instruction tracing is an important analysis tool, but instruction tracing is difficult to perform reliably. Processors have limited resources for supporting interrupt handling, and the actions of a tracing program consume the interrupt resources that are needed by the application program that is being analyzed. Moreover, if the tracing program is attempting to trace the operations of an interrupt handler, the tracing program and the interrupt handler may compete for the interrupt resources within the processor. Hence, it would be advantageous to provide hardware assistance within a processor to assist in tracing operations within the system that is being analyzed. The present invention is described in more detail further below with respect to the remaining figures.

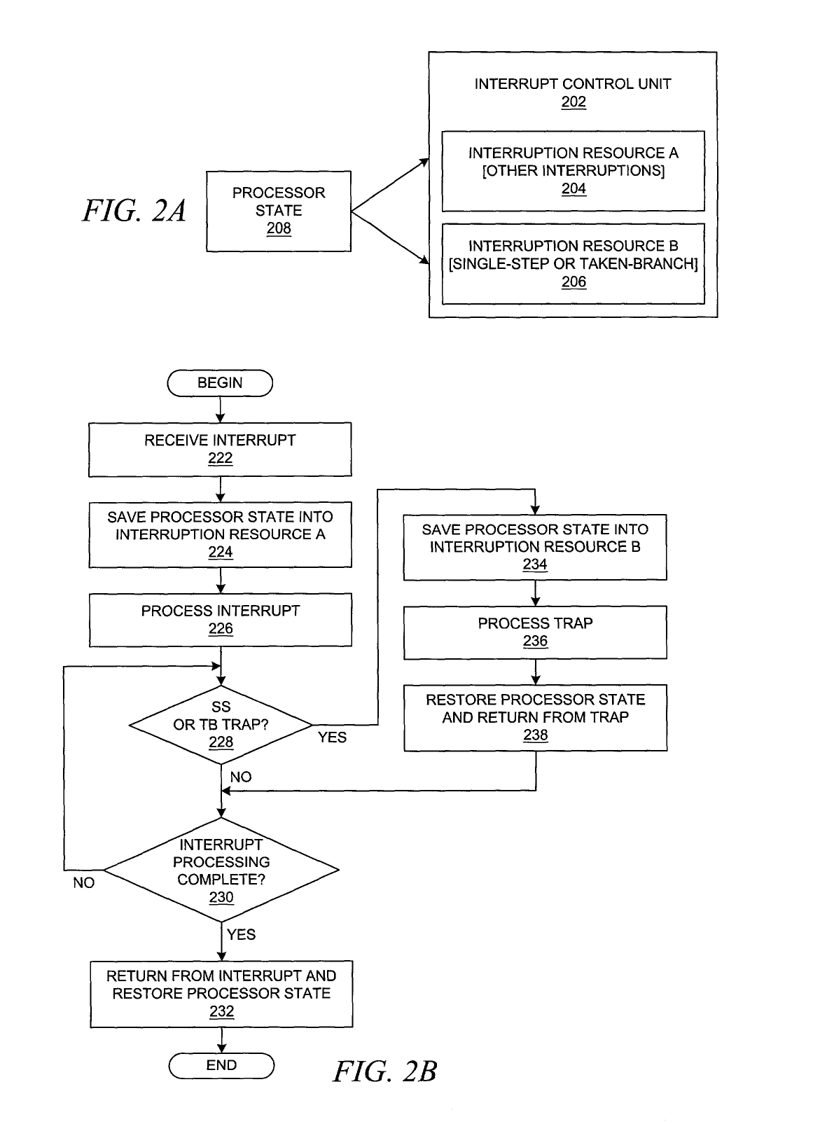

With reference now to FIG. 2A, a block diagram depicts a processor with two sets of interrupt resources into which a processor's current state may be saved in accordance with the present invention. As shown in FIG. 1C, when an interrupt occurs, a processor can save various informational values into a special set of interruption control registers; those informational values may include values from a different subset of registers within the processor. Any information that is necessary for restoring the processor's state after the interruption has been processed may be stored and retrieved. However, as mentioned above, since there is only one set of interruption resources within the processor, a tracing program cannot trace the actions of an interrupt handler without significant effort because the interrupt handler and the tracing program may compete for interruption resources.

A solution to this problem is depicted in FIG. 2A. In this example, a processor's interrupt control unit 202 contains multiple interruption resources, which are depicted as interruption resource 204 and interruption resource 206. Rather than being limited to the interrupt control unit, the multiple sets of interruption resources could be contained elsewhere within the processor, or a portion of the interruption resource could be contained within an interrupt control unit while the remaining portion is contain elsewhere within the processor. In other words, the interruption resource may comprise control registers within the interrupt control unit in addition to other structures outside of the interrupt control unit.

In this example, interruption resource 206 is reserved for processing single-step traps or taken-branch traps, while interruption resource 204 is available for any other type of interruption, such as interrupts or faults. It may be assumed that interruption resource 204 and interruption resource 206 are substantially identical except for the designation of the appropriate source event, i.e., interrupts vs. traps. Processor state 208 is saved into the appropriate interruption resource depending upon the determination of the type of interruption.

It may also be assumed that different types of interrupts can be mapped to different interruption resources. Although a distinction is made herein to categorize interruptions as either interrupt or traps, it should be noted that the present invention is applicable to multiple categories of interruptions wherein one category of interruptions is assigned to one or more interruption resources and another category of interruptions is assigned to a different set of interruption resources. For example, the Intel® IA-64 architecture categorizes interrupts into four types: aborts, interrupts, faults, and traps. An abort occurs when a processor has detected a machine-check condition, i.e., internal malfunction, or a processor reset. A fault occurs when an instruction has requested or requires an action which cannot or should not be carried out or which requires system intervention before the instruction can be executed. In general, an interrupt occurs when an external or independent entity requires attention, whereas a trap occurs when an instruction that has just executed requires system intervention.

With reference now to FIG. 2B, a flowchart depicts a process in which two sets of interruption resources are available for processing a trap concurrently with an interrupt in accordance with the present invention. The process begins with the processor receiving an interrupt (step 222), which causes the processor to save the current processor state into a first interruption resource (step 224). The interrupt is then processed (step 226), e.g., by invoking an interrupt handler through an interrupt vector table. The processor also monitors for single-step traps and taken/branch traps (step 228) while the interrupt handler is executing (step 230). At some point, the interrupt handler may complete without a trap occurring, and a return-from-interrupt by the interrupt handler causes the processor to restore the previous processor state (step 232).

While the interrupt handler is processing the interrupt, a taken-branch trap may occur, or the processor may have been in single-step mode. In either case, the processor then saves the current processor state into the second interruption resource (step 234) and begins processing the trap (step 236). After the trap has been processed, then a return-from-interrupt causes the processor to restore the processor state from the second interruption resource (step 238). The processor may have an internal flag to indicate that the second interruption resource contains the most recently saved processor state in order to be able to determine which interruption resource should be used to restored the processor's state on the return-from-interrupt. Alternatively, the processor may have a specially designated instruction, such as a return-from-trap, that allows a returning process to specifically designate which interruption resource should be used for restoring the processor's state.

The advantages of the present invention should be apparent in view of the detailed description of the invention that is provided above. With the present invention, the availability of multiple interruption resources allows the processor to save multiple processor states concurrently. If the processor is executing an interrupt handler and a taken-branch is triggered, then the processor can save the current processor state into a secondary interruption resource, thereby allowing the previously saved processor state to remain uncorrupted in the primary interruption resource. In this manner, an interrupt and a trap can be said to be processed concurrently.

Similarly, if the processor is already in single-step mode when an interrupt occurs, the processor can maintain the single-step mode as the interrupt handler is entered. More specifically, the processor saves the current processor state of the currently executing application prior to entering the interrupt handler; the processor can load the current processor state into the primary interruption resource. The processor can also single-step through the instructions within the interrupt handler. The processor saves the processor state of the interrupt handler prior to entering a handler for the single-step mode; the processor can load the processor state of the interrupt handler into a secondary interruption resource. As the processor executes each instruction in the interrupt handler, the processor state from the secondary interruption resource can be restored; another instruction is then executed, after which the processor state within the interrupt handler is saved into the secondary interruption resource again. In this manner, the present invention facilitates the generation of trace output information associated with an interrupt handler.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as microcode, nanocode, EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing an instruction within a processor, the method comprising:
executing an instruction within the processor, wherein the processor processes a plurality of types of interruptions, wherein the processor comprises a plurality of interruption resources, and wherein a type of interruption can be associated with a specific interruption resource; and
in response to receiving an interruption, saving processor state information into an interruption resource based on a type for the received interruption.

2. The method of claim 1 further comprising:
in response to saving processing state information into the interruption resource, invoking an interruption handler to process the received interruption.

3. The method of claim 1 wherein the types of interruptions comprise aborts, faults, interrupts, and traps.

4. The method of claim 1 wherein the plurality of interruption resources comprises a plurality of sets of interruption control registers.

5. The method of claim 1 further comprising:
holding concurrently multiple sets of processor state information in multiple interruption resources.

6. The method of claim 1 further comprising:
saving a first set of processor state information into a first interruption resource in response to receiving a first interruption, wherein the first interruption is a first type of interruption; and
prior to restoring the first set of processor state information, saving a second set of processor state information into a second interruption resource in response to receiving a second interruption, wherein the second interruption is a second type of interruption.

7. The method of claim 6 wherein the first interruption is an interrupt, and wherein the second interruption is a trap.

8. The method of claim 6 wherein the second interruption is a single-step trap.

9. A method for processing an instruction within a processor, the method comprising:
executing an instruction within the processor, wherein the processor comprises a plurality of interruption resources for saving processor state;
saving a first set of processor state information into a first interruption resource in response to receiving a first interruption; and
prior to restoring the first set of processor state information, saving a second set of processor state information into a second interruption resource in response to receiving a second interruption.

10. The method of claim 9 further comprising:
maintaining a single-step trap mode while executing instructions within an interruption handler.

11. A processor that performs operations specified by instructions fetched from a memory, the processor comprising:
means for fetching instructions from memory;
means for executing an instruction within the processor
means for processing a plurality of types of interruptions;
a plurality of interruption resources, wherein a type of interruption can be associated with a specific interruption resource; and
means for saving, in response to receiving an interruption, processor state information into an interruption resource based on a type for the received interruption.

12. The processor of claim 11 further comprising:
means for invoking an interruption handler to process the received interruption in response to saving processing state information into the interruption resource.

13. The processor of claim 11 wherein the types of interruptions comprise aborts, faults, interrupts, and traps.

14. The processor of claim 11 wherein the plurality of interruption resources comprises a plurality of sets of interruption control registers.

15. A processor that performs operations specified by instructions fetched from a memory, the processor comprising:
an instruction execution unit;
a first interruption resource for saving processor state;
a second interruption resource for saving processor state;
first saving means for saving a first set of processor state information into the first interruption resource in response to receiving a first interruption; and
second saving means for saving a second set of processor state information into the second interruption resource in response to receiving a second interruption prior to restoring the first set of processor state information.

16. The processor of claim 15 further comprising:
means for maintaining a single-step trap mode while executing instructions within an interruption handler.

17. The processor of claim 15 wherein the first interruption resource is a set of one or more registers and wherein the second interruption resource is a set of one or more registers.

18. A computer program product in a computer-readable medium for use in a data processing system for processing an instruction within a processor, the computer program product comprising:
means for executing an instruction within the processor, wherein the processor processes a plurality of types of interruptions, wherein the processor comprises a plurality of interruption resources, and wherein a type of interruption can be associated with a specific interruption resource; and
means for saving, in response to receiving an interruption, processor state information into an interruption resource based on a type for the received interruption.

19. The computer program product of claim 18 further comprising:
means for invoking an interruption handler to process the received interruption in response to saving processing state information into the interruption resource.

20. The computer program product of claim 18 wherein the types of interruptions comprise aborts, faults, interrupts, and traps.

21. The computer program product of claim 18 wherein the plurality of interruption resources comprises a plurality of sets of interruption control registers.

22. The computer program product of claim 18 further comprising:
means for saving a first set of processor state information into a first interruption resource in response to receiving a first interruption, wherein the first interruption is a first type of interruption; and
means for saving, prior to restoring the first set of processor state information, a second set of processor state information into a second interruption resource in response to receiving a second interruption, wherein the second interruption is a second type of interruption.

23. The computer program product of claim 22 wherein the first interruption is an interrupt, and wherein the second interruption is a trap.

24. The computer program product of claim 22 wherein the second interruption is a single-step trap.

25. A computer program product in a computer-readable medium for use in a data processing system for processing an instruction within a processor, the computer program product comprising:
means for executing an instruction within the processor, wherein the processor comprises a plurality of interruption resources for saving processor state;
means for saving a first set of processor state information into a first interruption resource in response to receiving a first interruption; and
means for saving a second set of processor state information into a second interruption resource in response to receiving a second interruption prior to restoring the first set of processor state information,

26. The computer program product of claim 25 further comprising:
means for maintaining a single-step trap mode while executing instructions within an interruption handler.
